(19) United States
(12) Patent Application Publication
(10) Pub. No.: US 2026/0213652 A1
(43) Pub. Date: Jul. 23, 2026

(54) RESONANT CONVERTER

(71) Applicant: LITE-ON Technology Corporation, Taipei (TW)

(72) Inventors: Bo-Ruei CIOU, Taipei (TW); Yen-An CHEN, Taipei (TW); Chen CHEN, Taipei (TW)

(21) Appl. No.: 19/260,632

(22) Filed: Jul. 7, 2025

Related U.S. Application Data
(60) Provisional application No. 63/747,368, filed on Jan. 21, 2025.

(30) Foreign Application Priority Data
May 16, 2025 (CN) 2025209646821

(51) Int. Cl. H02M 3/00; H02M 1/00; H02M 3/335

(52) U.S. Cl. CPC H02M 3/01; H02M 3/33573; H02M 1/0058

(57) ABSTRACT

The present disclosure is related to a resonant converter. The resonant converter includes a primary switching circuit, a resonant circuit, a transformer circuit and a secondary switching circuit. A plurality of resonant tanks of the transformer circuit are coupled to a plurality of output nodes of the primary switching circuit in a Wye connection. Each of a plurality of transformers of the transformer circuit includes a primary winding and a secondary winding. The primary windings are coupled to the resonant tanks in a delta connection. A plurality of input nodes of the secondary switching circuit are coupled to the secondary windings of the transformer circuit in the Wye connection. A magnetic flux density is reduced by the configuration of the resonant tanks so that the core loss is reduced and a better current balance effect is achieved.

### CROSS REFERENCE TO RELATED APPLICATION

This application claims the priority benefit of U.S. provisional patent application No. 63/747,368, filed Jan. 21, 2025, and Chinese Patent Application Serial Number 2025209646821, filed on May 16, 2025, the full disclosure of which is incorporated herein by reference.

### BACKGROUND

### Technical Field

The present disclosure is related to a power converter. More particularly, the embodiments are related to a resonant converter.

### Related Art

In low-voltage and high-current application scenarios such as charging piles, energy storage systems, and artificial intelligence servers, a three-phase interleaved topology is commonly employed in power circuits to distribute current stress. When characteristic deviations exist among circuit components, a phase current imbalance may occur. Accordingly, a current balancing system is typically configured to balance the phase currents. However, the additional current balancing system not only increases the overall size of the power circuit but also raises production costs.

Therefore, it is desirable to balance the phase currents without increasing the product size and production cost of the power circuit.

### SUMMARY

The embodiment of the present disclosure provides a resonant converter, which may achieve a better current balancing effect and reduce core loss without additional current balancing systems.

In order to achieve the above object and other related objects, the present disclosure provides a resonant converter including an input circuit, a primary switching circuit, a resonant circuit, a transformer circuit, a secondary switching circuit and an output circuit. The input circuit is configured to provide an input voltage. The primary switching circuit is coupled to the input circuit and includes a first output node, a second output node and a third output node. The resonant circuit includes a plurality of resonant tanks. Each of the plurality of resonant tanks includes a resonant capacitor and a resonant inductor connected in series. The plurality of resonant tanks are coupled to the first output node, the second output node and the third output node in a Wye connection. The transformer circuit includes a plurality of transformers. Each of the plurality of transformers includes a primary winding and a secondary winding. The primary windings are coupled to the plurality of resonant tanks in a delta connection. The secondary switching circuit is coupled to the transformer circuit and includes a first input node, a second input node and a third input node. The first input node, the second input node and the third input node are coupled to the secondary windings of the transformer circuit in the Wye connection. The output circuit is coupled to the secondary switching circuit and generates an output voltage.

According to the above, the resonant converter of the present disclosure may reduce the magnetic flux density by the configuration of the plurality of resonant tanks, thereby reducing the core loss, and a better current balancing effect is achieved when there are characteristic errors in circuit elements.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows in conjunction with the accompanying drawings, in which:

FIG. 1 is a schematic diagram of a power supply circuit according to an embodiment of the present disclosure.

FIG. 2 is a schematic diagram of a first embodiment of a resonant converter according to an embodiment of the present disclosure.

FIG. 3 is a schematic diagram of a second embodiment of a resonant converter according to an embodiment of the present disclosure.

FIG. 4 is a schematic diagram of a third embodiment of a resonant converter according to an embodiment of the present disclosure.

FIG. 5 is a schematic diagram of a fourth embodiment of a resonant converter according to an embodiment of the present disclosure.

FIG. 6 is a schematic diagram of a first embodiment of a control signal according to an embodiment of the present disclosure.

FIG. 7 is a schematic diagram of an embodiment of a dead time according to an embodiment of the present disclosure.

FIG. 8 is a schematic diagram of a second embodiment of a control signal according to an embodiment of the disclosure.

FIG. 9 is a comparative diagram showing three-phase current errors among a resonant converter according to an embodiment of the present disclosure and a full-bridge to full-bridge resonant converter.

FIG. 10A is a perspective schematic diagram of an integrated magnetic core module according to an embodiment of the present disclosure.

FIG. 10B is another perspective schematic diagram of an integrated magnetic core module according to an embodiment of the present disclosure.

FIG. 10C is a cross-sectional schematic diagram of an integrated magnetic core module according to an embodiment of the present disclosure.

FIG. 10D is another cross-sectional schematic diagram of an integrated magnetic core module according to an embodiment of the present disclosure.

FIG. 11 is a further perspective schematic diagram of an integrated magnetic core module according to an embodiment of the present disclosure.

FIG. 12 is another cross-sectional schematic diagram of an integrated magnetic core module according to an embodiment of the present disclosure.

### DETAILED DESCRIPTION OF THE EMBODIMENTS

The present invention will be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that the description of the present invention will be thorough and complete and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but not in function. In the following description and in the claims, the terms “include/including” and “comprise/comprising” are used in an open-ended fashion and thus should be interpreted as “including but not limited to”. “Substantial/substantially” means that, within an acceptable error range, a person skilled in the art may solve the technical problem in a certain error range to achieve the basic technical effect.

The following description is of the best-contemplated mode of carrying out the invention. This description is provided for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only includes these elements but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

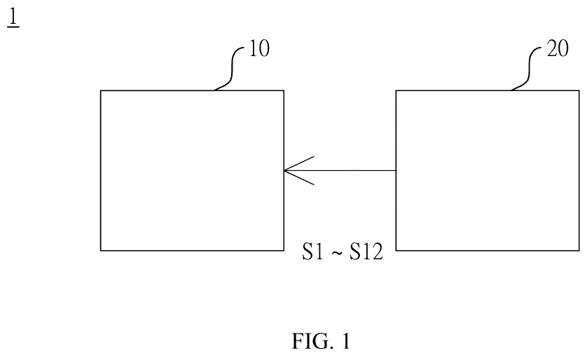

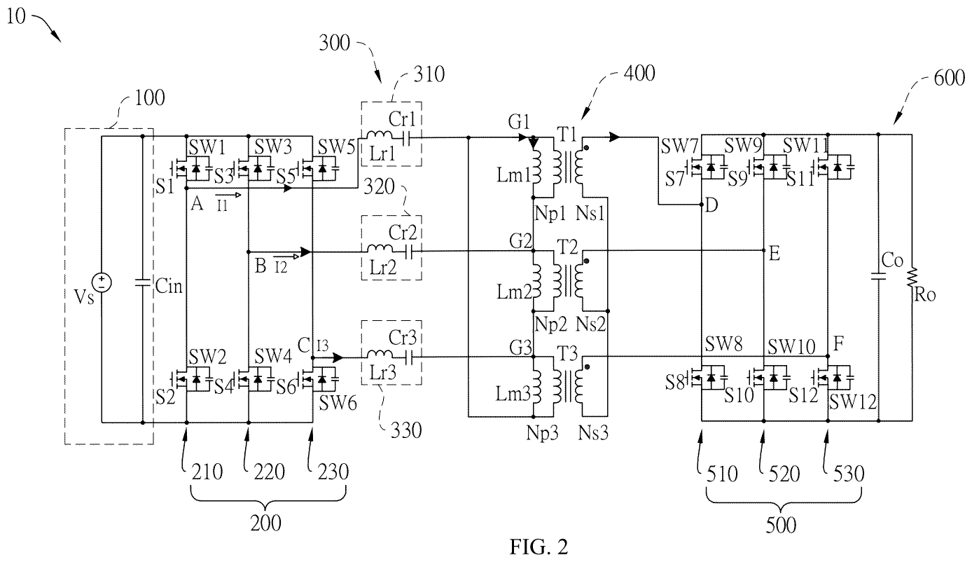

Referring to FIG. 1 and FIG. 2, FIG. 1 is a schematic diagram of a power supply circuit according to an embodiment of the present disclosure, and FIG. 2 is a schematic diagram of a first embodiment of a resonant converter according to an embodiment of the present disclosure. The power supply circuit 1 may at least include a resonant converter 10 and a control circuit 20. The resonant converter 10 is electrically connected to the control circuit 20. The resonant converter 10, as a DC-to-DC converter, is configured to output a DC voltage to a load or circuit electrically connected thereto. For example, the resonant converter 10 outputs the DC voltage to a voltage regulator (VR) circuit. The control circuit 20 is configured to provide control signals required for an operation of the resonant converter 10, such as control signals S1 to S12. The control circuit 20 is, for example, a microcontroller; however, the present disclosure is not limited thereto.

The resonant converter 10 includes an input circuit 100, a primary switching circuit 200, a resonant circuit 300, a transformer circuit 400, a secondary switching circuit 500, and an output circuit 600. The secondary switching circuit 500 includes a first input node D, a second input node E, and a third input node F.

The input circuit 100 includes a voltage source Vs and an input capacitor Cin. The voltage source Vs is configured to provide an input voltage. The two terminals of the input capacitor Cin are respectively coupled to the voltage source Vs such that the input capacitor Cin is connected in parallel with the voltage source Vs.

The primary switching circuit 200 is coupled to the input circuit 100. The primary switching circuit 200 includes a first bridge arm 210, a second bridge arm 220, and a third bridge arm 230. The first bridge arm 210, the second bridge arm 220, and the third bridge arm 230 are connected in parallel with each other. The first bridge arm 210 includes a first switching unit SW1 and a second switching unit SW2 connected in series, and a first output node A is located between the first switching unit SW1 and the second switching unit SW2. A first terminal of the first switching unit SW1 is coupled to a first terminal of the input capacitor Cin, and a second terminal of the first switching unit SW1 is coupled to the first output node A. A control terminal of the first switching unit SW1 receives the control signal S1. A first terminal of the second switching unit SW2 is coupled to the first output node A, and a second terminal of the second switching unit SW2 is coupled to a second terminal of the input capacitor Cin. A control terminal of the second switching unit SW2 receives the control signal S2. The second bridge arm 220 includes a third switching unit SW3 and a fourth switching unit SW4 connected in series, and a second output node B is located between the third switching unit SW3 and the fourth switching unit SW4. A first terminal of the third switching unit SW3 is coupled to the first terminal of the input capacitor Cin, and a second terminal of the third switching unit SW3 is coupled to the second output node B. A control terminal of the third switching unit SW3 receives the control signal S3. A first terminal of the fourth switching unit SW4 is coupled to the second output node B, and a second terminal of the fourth switching unit SW4 is coupled to the second terminal of the input capacitor Cin. A control terminal of the fourth switching unit SW4 receives the control signal S4. The third bridge arm 230 includes a fifth switching unit SW5 and a sixth switching unit SW6 connected in series, and a third output node C is located between the fifth switching unit SW5 and the sixth switching unit SW6. A first terminal of the fifth switching unit SW5 is coupled to the first terminal of the input capacitor Cin, and a second terminal of the fifth switching unit SW5 is coupled to the third output node C. A control terminal of the fifth switching unit SW5 receives the control signal S5. A first terminal of the sixth switching unit SW6 is coupled to the third output node C, and a second terminal of the sixth switching unit SW6 is coupled to the second terminal of the input capacitor Cin. A control terminal of the sixth switching unit SW6 receives the control signal S6.

The resonant circuit 300 includes a plurality of resonant tanks. Each of the plurality of resonant tanks includes a resonant capacitor and a resonant inductor connected in series with each other. The plurality of resonant tanks are coupled to the primary switching circuit 200 in a Wye connection. The resonant circuit 300 includes a first resonant tank 310, a second resonant tank 320, and a third resonant tank 330. The first resonant tank 310 includes a first resonant inductor Lr1 and a first resonant capacitor Cr1. A first terminal of the first resonant inductor Lr1 is coupled to the first output node A, and a second terminal of the first resonant inductor Lr1 is coupled to a first terminal of the first resonant capacitor Cr1. A second terminal of the first resonant capacitor Cr1 is coupled to a primary of the transformer circuit 400. The second resonant tank 320 includes a second resonant inductor Lr2 and a second resonant capacitor Cr2. A first terminal of the second resonant inductor Lr2 is coupled to the second output node B, and a second terminal of the second resonant inductor Lr2 is coupled to a first terminal of the second resonant capacitor Cr2. A second terminal of the second resonant capacitor Cr2 is coupled to the primary of the transformer circuit 400. The third resonant tank 330 includes a third resonant inductor Lr3 and a third resonant capacitor Cr3. A first terminal of the third resonant inductor Lr3 is coupled to the third output node C, and a second terminal of the third resonant inductor Lr3 is coupled to a first terminal of the third resonant capacitor Cr3. A second terminal of the third resonant capacitor Cr3 is coupled to the primary of the transformer circuit 400. In this embodiment, the first resonant inductor Lr1, the second resonant inductor Lr2, and the third resonant inductor Lr3 are coupled to the first output node A, the second output node B, and the third output node C in the Wye connection. The first resonant capacitor Cr1, the second resonant capacitor Cr2, and the third resonant capacitor Cr3 are coupled to the primary of the transformer circuit 400 in the Wye connection.

The transformer circuit 400 includes a first transformer T1, a second transformer T2, and a third transformer T3. A node G1 is located between the first resonant capacitor Cr1 and a primary of the first transformer T1. A node G2 is located between the second resonant capacitor Cr2 and a primary of the second transformer T2. A node G3 is located between the third resonant capacitor Cr3 and a primary of the third transformer T3. The first transformer T1 includes a primary winding Np1, a secondary winding Ns1, and a magnetizing inductor Lm1. A first terminal of the primary winding Np1 is coupled to the node G1, and a second terminal of the primary winding Np1 is coupled to the node G2. The magnetizing inductor Lm1 is coupled between the first terminal and the second terminal of the primary winding Np1. A first terminal of the secondary winding Ns1 is coupled to the first input node D, and a second terminal of the secondary winding Ns1 is coupled to the second transformer T2. The second transformer T2 includes a primary winding Np2, a secondary winding Ns2, and a magnetizing inductor Lm2. A first terminal of the primary winding Np2 is coupled to the node G2, and a second terminal of the primary winding Np2 is coupled to the node G3. The magnetizing inductor Lm2 is coupled between the first terminal and the second terminal of the primary winding Np2. A first terminal of the secondary winding Ns2 is coupled to the second input node E, and a second terminal of the secondary winding Ns2 is coupled to the second terminal of the secondary winding Ns1 and the third transformer T3. The third transformer T3 includes a primary winding Np3, a secondary winding Ns3, and a magnetizing inductor Lm3. A first terminal of the primary winding Np3 is coupled to the node G3, and a second terminal of the primary winding Np3 is coupled to the node G1. The magnetizing inductor Lm3 is coupled between the first terminal and the second terminal of the primary winding Np3. A first terminal of the secondary winding Ns3 is coupled to the third input node F, and a second terminal of the secondary winding Ns3 is coupled to the second terminal of the secondary winding Ns1 of the first transformer T1 and the second terminal of the secondary winding Ns2 of the second transformer T2. In this embodiment, the primary winding Np1 of the first transformer T1, the primary winding Np2 of the second transformer T2, and the primary winding Np3 of the third transformer T3 are connected in a delta connection. The secondary winding Ns1 of the first transformer T1, the secondary winding Ns2 of the second transformer T2, and the secondary winding Ns3 of the third transformer T3 are connected to the secondary switching circuit 500 in the Wye connection.

The secondary switching circuit 500 includes a first rectification unit 510, a second rectification unit 520, and a third rectification unit 530. The first rectification unit 510, the second rectification unit 520, and the third rectification unit 530 are coupled in parallel with each other. The first rectification unit 510 includes a seventh switching unit SW7 and an eighth switching unit SW8 connected in series. The first input node D is located between the seventh switching unit SW7 and the eighth switching unit SW8. A first terminal of the seventh switching unit SW7 is coupled to the output circuit 600, a second terminal of the seventh switching unit SW7 is coupled to the first input node D, and a control terminal of the seventh switching unit SW7 receives the control signal S7. A first terminal of the eighth switching unit SW8 is coupled to the first input node D, a second terminal of the eighth switching unit SW8 is coupled to the output circuit 600, and a control terminal of the eighth switching unit SW8 receives the control signal S8. The second rectification unit 520 includes a ninth switching unit SW9 and a tenth switching unit SW10 connected in series. The second input node E is located between the ninth switching unit SW9 and the tenth switching unit SW10. A first terminal of the ninth switching unit SW9 is coupled to the output circuit 600, a second terminal of the ninth switching unit SW9 is coupled to the second input node E, and a control terminal of the ninth switching unit SW9 receives the control signal S9. A first terminal of the tenth switching unit SW10 is coupled to the second input node E, a second terminal of the tenth switching unit SW10 is coupled to the output circuit 600, and a control terminal of the tenth switching unit SW10 receives the control signal S10. The third rectification unit 530 includes an eleventh switching unit SW11 and a twelfth switching unit SW12 connected in series. The third input node F is located between the eleventh switching unit SW11 and the twelfth switching unit SW12. A first terminal of the eleventh switching unit SW11 is coupled to the output circuit 600, a second terminal of the eleventh switching unit SW11 is coupled to the third input node F, and a control terminal of the eleventh switching unit SW11 receives the control signal S11. A first terminal of the twelfth switching unit SW12 is coupled to the third input node F, a second terminal of the twelfth switching unit SW12 is coupled to the output circuit 600, and a control terminal of the twelfth switching unit SW12 receives the control signal S12. In the embodiment, the first input node D, the second input node E, and the third input node F are coupled to a secondary of the transformer circuit 400 in the Wye connection.

In one embodiment, the first switching unit SW1 to the twelfth switching unit SW12 may be metal-oxide-semiconductor field-effect transistors (MOSFETs), trench MOSFETs, or insulated gate bipolar transistors (IGBTs), and the present disclosure is not limited thereto.

The output circuit 600 is coupled to the secondary switching circuit 500 and includes an output capacitor Co and an output resistor Ro connected in parallel with each other. A first terminal of the output capacitor Co and a first terminal of the output resistor Ro are coupled to the first terminals of the seventh switching unit SW7, the ninth switching unit SW9, and the eleventh switching unit SW11. A second terminal of the output capacitor Co and a second terminal of the output resistor Ro are coupled to the second terminals of the eighth switching unit SW8, the tenth switching unit SW10, and the twelfth switching unit SW12. The output circuit 600 is configured to generate an output voltage to a load coupled to the output circuit 600.

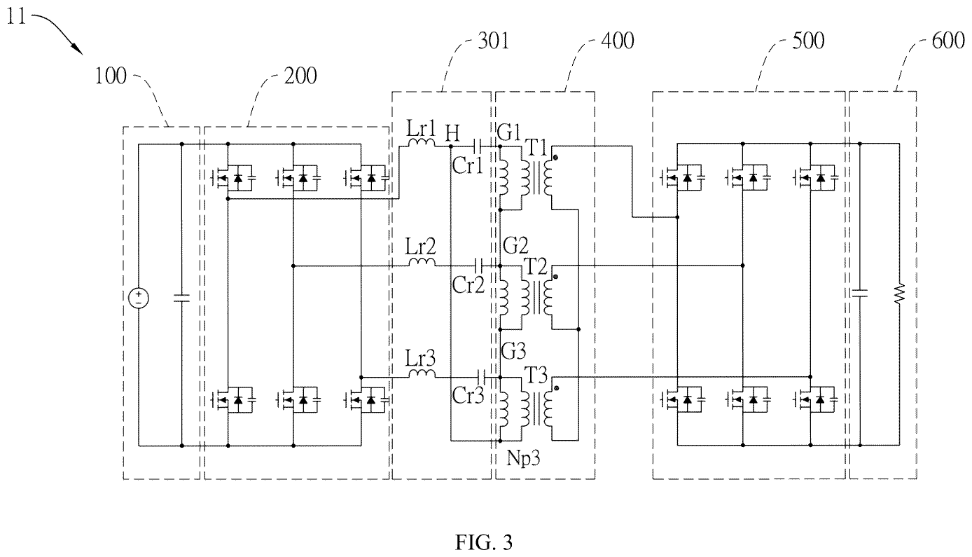

Please refer to FIG. 3. FIG. 3 is a schematic diagram of a second embodiment of a resonant converter according to the present disclosure. In FIG. 2 and FIG. 3, elements with the same reference designations have the same functions and will not be described again herein. The difference between FIG. 3 and FIG. 2 is that a resonant converter 11 includes the input circuit 100, the primary switching circuit 200, a resonant circuit 301, the transformer circuit 400, the secondary switching circuit 500, and the output circuit 600. In this embodiment, a node H is located between the second terminal of the first resonant inductor Lr1 and the first terminal of the first resonant capacitor Cr1, and the second terminal of the primary winding Np3 of the third transformer T3 is coupled to the node H. Therefore, in this embodiment, the primary winding Np1, the primary winding Np2, the primary winding Np3, the first resonant capacitor Cr1, the second resonant capacitor Cr2 and the third resonant capacitor Cr3 are coupled to each other in the delta connection. The first resonant inductor Lr1, the second resonant inductor Lr2, and the third resonant inductor Lr3 are coupled to the primary switching circuit 200 in the Wye connection.

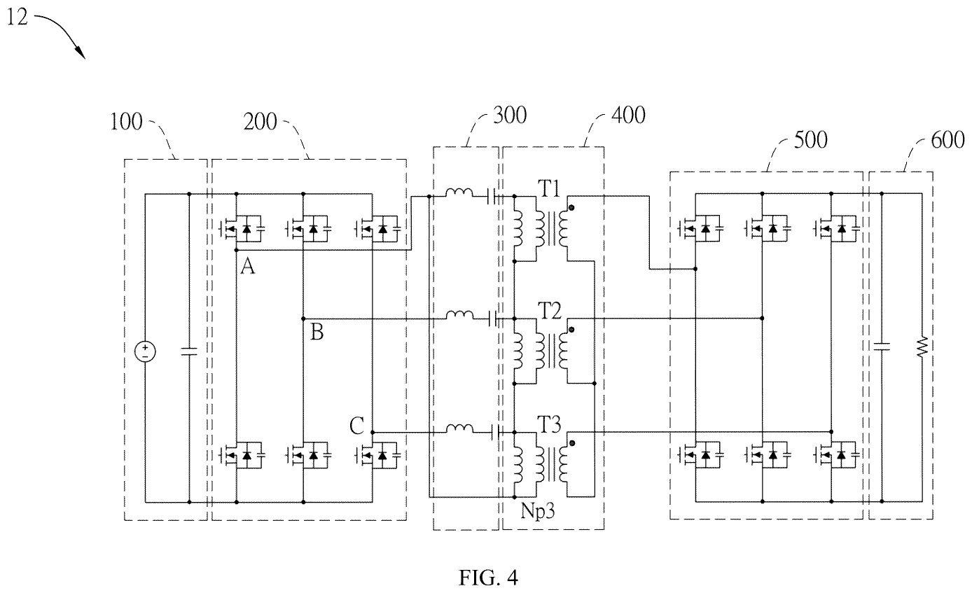

Please refer to FIG. 4, which is a schematic diagram of a third embodiment of a resonant converter according to an embodiment of the present disclosure. In FIG. 2 and FIG. 4, elements with the same reference designations have the same functions and will not be described again herein. The difference between FIG. 4 and FIG. 2 is that a resonant converter 12 includes the input circuit 100, the primary switching circuit 200, the resonant circuit 300, the transformer circuit 400, the secondary switching circuit 500, and the output circuit 600. In this embodiment, the second terminal of the primary winding Np3 of the third transformer T3 is coupled to the first output node A. Therefore, in this embodiment, the primary winding Np1 of the first transformer T1, the primary winding Np2 of the second transformer T2, the primary winding Np3 of the third transformer T3, the first resonant capacitor Cr1, the second resonant capacitor Cr2, the third resonant capacitor Cr3, the first resonant inductor Lr1, the second resonant inductor Lr2, and the third resonant inductor Lr3 are coupled to each other in the delta connection.

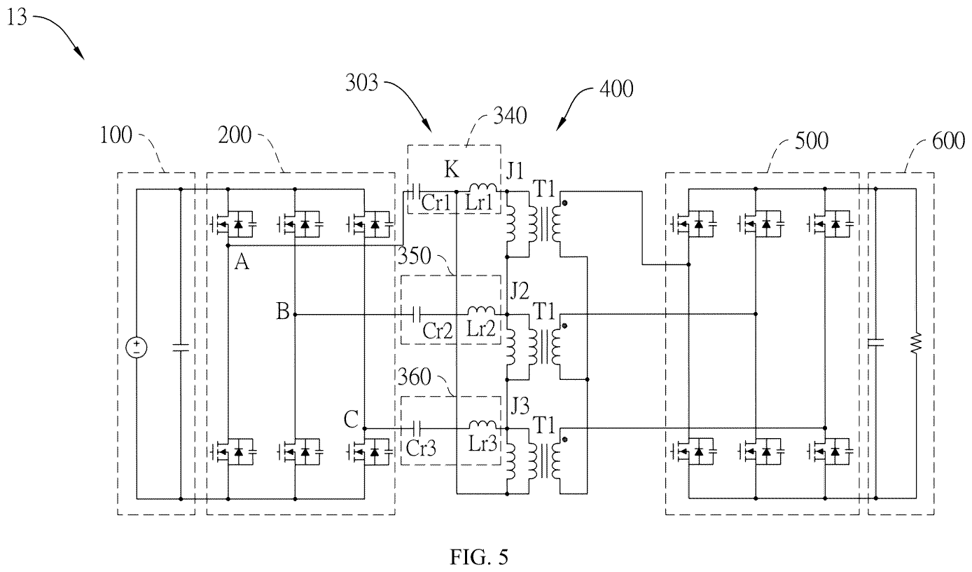

Please refer to FIG. 5, which is a schematic diagram of a fourth embodiment of a resonant converter according to an embodiment of the present disclosure. In FIG. 2 and FIG. 5, elements with the same reference designations have the same functions and will not be described again herein. The difference between FIG. 5 and FIG. 2 is that a resonant converter 13 includes the input circuit 100, the primary switching circuit 200, a resonant circuit 303, the transformer circuit 400, the secondary switching circuit 500, and the output circuit 600.

The resonant circuit 303 includes a first resonant tank 340, a second resonant tank 350, and a third resonant tank 360. The first resonant tank 340 includes a first resonant inductor Lr1 and a first resonant capacitor Cr1. A node K is located between the first resonant capacitor Cr1 and the first resonant inductor Lr1. A first terminal of the first resonant capacitor Cr1 is coupled to the first output node A, and a second terminal of the first resonant capacitor Cr1 is coupled to the node K. A first terminal of the first resonant inductor Lr1 is coupled to the node K, and a second terminal of the first resonant inductor Lr1 is coupled to the first terminal of the primary winding Np1 of the transformer circuit 400. The second resonant tank 350 includes a second resonant inductor Lr2 and a second resonant capacitor Cr2. A first terminal of the second resonant capacitor Cr2 is coupled to the second output node B, and a second terminal of the second resonant capacitor Cr2 is coupled to the second resonant inductor Lr2. A first terminal of the second resonant inductor Lr2 is coupled to a second terminal of the second resonant capacitor Cr2. A second terminal of the second resonant inductor Lr2 is coupled to the first terminal of the primary winding Np2 of the transformer circuit 400. The third resonant tank 360 includes a third resonant inductor Lr3 and a third resonant capacitor Cr3. A first terminal of the third resonant capacitor Cr3 is coupled to the third output node C, and a second terminal of the third resonant capacitor Cr3 is coupled to the third resonant inductor Lr3. A first terminal of the third resonant inductor Lr3 is coupled to a second terminal of the third resonant capacitor Cr3, and a second terminal of the third resonant inductor Lr3 is coupled to the first terminal of the primary winding Np3 of the transformer circuit 400. In this embodiment, the first resonant capacitor Cr1, the second resonant capacitor Cr2, and the third resonant capacitor Cr3 are coupled to the primary switching circuit 200 in the Wye connection.

In this embodiment, a node J1 is located between the first resonant inductor Lr1 and the primary of the first transformer T1, a node J2 is located between the second resonant inductor Lr2 and the primary of the second transformer T2, and a node J3 is located between the third resonant inductor Lr3 and the primary of the third transformer T3. The first terminal of the primary winding Np1 of the first transformer T1 is coupled to the node J1, and the second terminal of the primary winding Np1 of the first transformer T1 is coupled to the node J2. The first terminal of the primary winding Np2 of the second transformer T2 is coupled to the node J2, and the second terminal of the primary winding Np2 of the second transformer T2 is coupled to the node J3. The first terminal of the primary winding Np3 of the third transformer T3 is coupled to the node J3, and the second terminal of the primary winding Np3 of the third transformer T3 is coupled to the node K. Therefore, in this embodiment, the primary winding Np1 of the first transformer T1, the primary winding Np2 of the second transformer T2, the primary winding Np3 of the third transformer T3, the first resonant inductor Lr1, the second resonant inductor Lr2, and the third resonant inductor Lr3 are coupled in the delta connection.

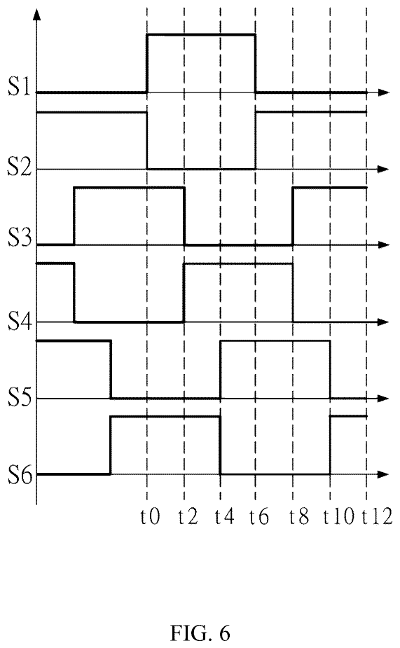

Please refer to FIG. 6, which is a schematic diagram of a first embodiment of control signals according to an embodiment of the present disclosure. In FIG. 6, a horizontal axis represents time, and a vertical axis represents voltage level. FIG. 6 includes the control signals S1 to S6. Each control signal includes a high voltage level and a low voltage level. A phase difference between the control signal S1 and the control signal S2 is 180 degrees, and the control signal S1 and the control signal S2 are complementary to each other. A phase difference between the control signal S3 and the control signal S4 is 180 degrees, and the control signal S3 and the control signal S4 are complementary to each other. A phase difference between the control signal S5 and the control signal S6 is 180 degrees, and the control signal S5 and the control signal S6 are complementary to each other. A phase difference between the control signal S1 and the control signal S3 is 120 degrees. A phase difference between the control signal S3 and the control signal S5 is 120 degrees. A phase difference between the control signal S2 and the control signal S4 is 120 degrees. A phase difference between the control signal S4 and the control signal S6 is 120 degrees.

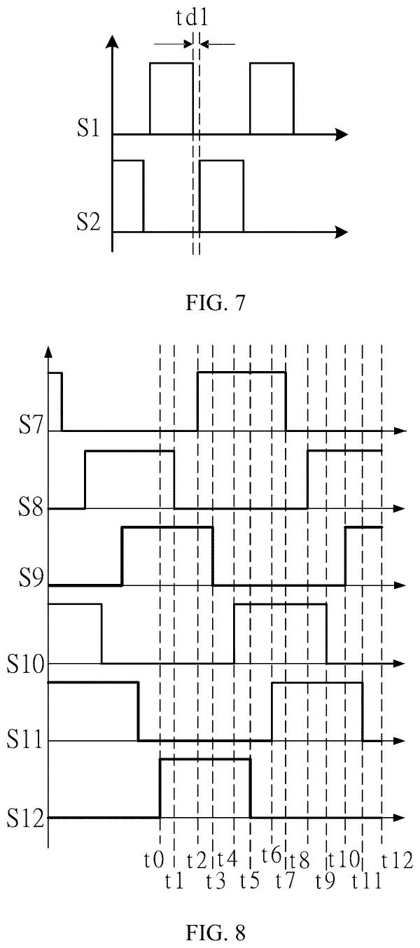

In one embodiment, there is a first dead time td1 between the control signal S1 and the control signal S2, there is a first dead time td1 between the control signal S3 and the control signal S4, and there is a first dead time td1 between the control signal S5 and the control signal S6. For example, in FIG. 7, the first dead time td1 is between a falling edge of the control signal S1 and a rising edge of the control signal S2. Thereby, the switches of the same bridge arm (e.g., the first switching unit SW1 and the second switching unit SW2) may be prevented from being turned on at the same time. In one embodiment, a duration of the first dead time td1 may be determined by parasitic capacitances of a plurality of switching units of the primary switching circuit 200 and the secondary switching circuit 500 and magnetizing inductors of the plurality of transformers. For example, when the magnetizing inductors are small, the switching units may be discharged quickly, so the duration of the first dead time td1 may be relatively short. When the magnetizing inductors are larger, the switching units need a longer discharge time, so the duration of the first dead time td1 may be relatively longer to ensure that the switching units operate in zero voltage switching.

Please refer to FIG. 8, which is a schematic diagram of a second embodiment of control signals according to an embodiment of the present disclosure. In FIG. 8, a horizontal axis represents time, and a vertical axis represents voltage level. FIG. 8 includes the control signals S7 to S12. Each control signal includes a high voltage level and a low voltage level. The control signal S7 and the control signal S8 are complementary to each other. The control signal S9 and the control signal S10 are complementary to each other. The control signal S11 and the control signal S12 are complementary to each other. Thereby, switches of the same rectification unit (for example, the seventh switching unit SW7 and the eighth switching unit SW8) may be prevented from being turned on at the same time.

The operation of the resonant converter of the present disclosure is described below with reference to FIG. 2, FIG. 6 and FIG. 8. At time t0 to t1, the first switching unit SW1 is turned on, the second switching unit SW2 is turned off, the third switching unit SW3 is turned on, the fourth switching unit SW4 is turned off, the fifth switching unit SW5 is turned off, and the sixth switching unit SW6 is turned on. The first switching unit SW1 generates and transmits an input current I1 to the first resonant tank 310 according to the input voltage. The first resonant tank 310 generates a resonant current according to the input current I1. The second switching unit SW2 generates and transmits an input current I2 to the second resonant tank 320 according to the input voltage. The second resonant tank 320 generates a resonant current according to the input current I2. The primary of the first transformer T1 generates a first input voltage and a first input current according to the resonant current of the first resonant tank 310. The secondary of the first transformer T1 generates a second output voltage and a second output current according to the first input voltage and the first input current. The operation of the second transformer T2 is similar to that of the first transformer T1 and thus will not be described in detail herein. The seventh switching unit SW7 is turned off, the eighth switching unit SW8 is turned on, the ninth switching unit SW9 is turned on, the tenth switching unit SW10 is turned off, the eleventh switching unit SW11 is turned off, and the twelfth switching unit SW12 is turned on. The ninth switching unit SW9 generates an output current according to a second output voltage of the secondary of the second transformer T2. The output current is input to the output capacitor Co and the output resistor Ro to generate the output voltage.

At time t1 to t2, the first switching unit SW1 is turned on, the second switching unit SW2 is turned off, the third switching unit SW3 is turned on, the fourth switching unit SW4 is turned off, the fifth switching unit SW5 is turned off, and the sixth switching unit SW6 is turned on. Correspondingly, the seventh switching unit SW7 is turned off, the eighth switching unit SW8 is turned off, the ninth switching unit SW9 is turned on, the tenth switching unit SW10 is turned off, the eleventh switching unit SW11 is turned off, and the twelfth switching unit SW12 is turned on. The ninth switching unit SW9 generates the output current according to the second output voltage of the secondary of the second transformer T2, and the output current is input to the output capacitor Co and the output resistor Ro to generate the output voltage.

At time t2 to t3, the first switching unit SW1 is turned on, the second switching unit SW2 is turned off, the third switching unit SW3 is turned off, the fourth switching unit SW4 is turned on, the fifth switching unit SW5 is turned off, and the sixth switching unit SW6 is turned on. The first switching unit SW1 generates and transmits the input current I1 to the first resonant tank 310 according to the input voltage. Correspondingly, the seventh switching unit SW7 is turned on, the eighth switching unit SW8 is turned off, the ninth switching unit SW9 is turned on, the tenth switching unit SW10 is turned off, the eleventh switching unit SW11 is turned off, and the twelfth switching unit SW12 is turned on. The seventh switching unit SW7 generates the output current according to the second output voltage of the secondary of the first transformer T1, and the output current is input to the output capacitor Co and the output resistor Ro to generate the output voltage.

At time t3 to t4, the first switching unit SW1 is turned on, the second switching unit SW2 is turned off, the third switching unit SW3 is turned off, the fourth switching unit SW4 is turned on, the fifth switching unit SW5 is turned off, and the sixth switching unit SW6 is turned on. Correspondingly, the seventh switching unit SW7 is turned on, the eighth switching unit SW8 is turned off, the ninth switching unit SW9 is turned off, the tenth switching unit SW10 is turned off, the eleventh switching unit SW11 is turned off, and the twelfth switching unit SW12 is turned on. The seventh switching unit SW7 generates the output current according to the second output voltage of the secondary of the first transformer T1, and the output current is input to the output capacitor Co and the output resistor Ro to generate the output voltage.

At time t4 to t5, the first switching unit SW1 is turned on, the second switching unit SW2 is turned off, the third switching unit SW3 is turned off, the fourth switching unit SW4 is turned on, the fifth switching unit SW5 is turned on, and the sixth switching unit SW6 is turned off. The first switching unit SW1 generates and transmits the input current I1 to the first resonant tank 310. The fifth switching unit SW5 generates and transmits an input current I3 to the third resonant tank 330 according to the input voltage. The primary of the first transformer T1 generates the first input voltage and the first input current according to the resonant current of the first resonant tank 310. The secondary of the first transformer T1 generates the second output voltage and the second output current according to the first input voltage and the first input current. An operation of the third transformer T3 is similar to that of the first transformer T1 and thus will not be described in detail herein. Correspondingly, the seventh switching unit SW7 is turned on, the eighth switching unit SW8 is turned off, the ninth switching unit SW9 is turned off, the tenth switching unit SW10 is turned on, the eleventh switching unit SW11 is turned off, and the twelfth switching unit SW12 is turned on. The seventh switching unit SW7 generates the output current according to the second output voltage of the secondary of the first transformer T1. The output current is input to the output capacitor Co and the output resistor Ro to generate the output voltage.

At time t5 to t6, the first switching unit SW1 is turned on, the second switching unit SW2 is turned off, the third switching unit SW3 is turned off, the fourth switching unit SW4 is turned on, the fifth switching unit SW5 is turned on, and the sixth switching unit SW6 is turned off. Correspondingly, the seventh switching unit SW7 is turned on, the eighth switching unit SW8 is turned off, the ninth switching unit SW9 is turned off, the tenth switching unit SW10 is turned on, the eleventh switching unit SW11 is turned off, and the twelfth switching unit SW12 is turned off. The seventh switching unit SW7 generates the output current according to the second output voltage of the secondary of the first transformer T1. The output current is input to the output capacitor Co and the output resistor Ro to generate the output voltage.

At time t6 to t7, the first switching unit SW1 is turned off, the second switching unit SW2 is turned on, the third switching unit SW3 is turned off, the fourth switching unit SW4 is turned on, the fifth switching unit SW5 is turned on, and the sixth switching unit SW6 is turned off. The fifth switching unit SW5 generates and transmits the input current I3 to the third resonant tank 330, and the third resonant tank 330 generates a resonant current according to the input current I3. The primary of the third transformer T3 generates a first input voltage and a first input current according to the resonant current of the third resonant tank 330. The secondary of the third transformer T3 generates a second output voltage and a second output current according to the first input voltage and the first input current. Correspondingly, the seventh switching unit SW7 is turned on, the eighth switching unit SW8 is turned off, the ninth switching unit SW9 is turned off, the tenth switching unit SW10 is turned on, the eleventh switching unit SW11 is turned on, and the twelfth switching unit SW12 is turned off. The eleventh switching unit SW11 generates an output current according to the second output voltage of the secondary of the third transformer T3. The output current is input to the output capacitor Co and the output resistor Ro to generate the output voltage.

At time t7 to t8, the first switching unit SW1 is turned off, the second switching unit SW2 is turned on, the third switching unit SW3 is turned off, the fourth switching unit SW4 is turned on, the fifth switching unit SW5 is turned on, and the sixth switching unit SW6 is turned off. Correspondingly, the seventh switching unit SW7 is turned off, the eighth switching unit SW8 is turned off, the ninth switching unit SW9 is turned off, the tenth switching unit SW10 is turned on, the eleventh switching unit SW11 is turned on, and the twelfth switching unit SW12 is turned off. The eleventh switching unit SW11 generates the output current according to the second output voltage of the secondary of the third transformer T3. The output current is input to the output capacitor Co and the output resistor Ro to generate an output voltage.

At time t8 to t9, the first switching unit SW1 is turned off, the second switching unit SW2 is turned on, the third switching unit SW3 is turned on, the fourth switching unit SW4 is turned off, the fifth switching unit SW5 is turned on, and the sixth switching unit SW6 is turned off. The third switching unit SW3 generates and transmits the input current I2 to the second resonant tank 320, and the second resonant tank 320 generates a resonant current according to the input current I2. The fifth switching unit SW5 generates and transmits the input current I3 to the third resonant tank 330. The third resonant tank 330 generates a resonant current according to the input current I3. The primary of the second transformer T2 generates the first input voltage and the first input current according to the resonant current of the second resonant tank 320. The secondary of the second transformer T2 generates a second output voltage and a second output current according to the first input voltage and the first input current. An operation of the third transformer T3 is similar to that of the second transformer T2 and thus will not be described in detail herein. Correspondingly, the seventh switching unit SW7 is turned off, the eighth switching unit SW8 is turned on, the ninth switching unit SW9 is turned off, the tenth switching unit SW10 is turned on, the eleventh switching unit SW11 is turned on, and the twelfth switching unit SW12 is turned off. The eleventh switching unit SW11 generates the output current according to the second output voltage of the secondary of the third transformer T3. The output current is input to the output capacitor Co and the output resistor Ro to generate the output voltage.

At time t9 to t10, the first switching unit SW1 is turned off, the second switching unit SW2 is turned on, the third switching unit SW3 is turned on, the fourth switching unit SW4 is turned off, the fifth switching unit SW5 is turned on, and the sixth switching unit SW6 is turned off. Correspondingly, the seventh switching unit SW7 is turned off, the eighth switching unit SW8 is turned on, the ninth switching unit SW9 is turned off, the tenth switching unit SW10 is turned off, the eleventh switching unit SW11 is turned on, and the twelfth switching unit SW12 is turned off. The eleventh switching unit SW11 generates the output current according to the second voltage of the secondary of the third transformer T3. The output current is input to the output capacitor Co and the output resistor Ro to generate the output voltage.

At time t10 to t11, the first switching unit SW1 is turned off, the second switching unit SW2 is turned on, the third switching unit SW3 is turned on, the fourth switching unit SW4 is turned off, the fifth switching unit SW5 is turned off, and the sixth switching unit SW6 is turned on. The third switching unit SW3 generates and transmits the input current I2 to the second resonant tank 320. The primary of the second transformer T2 generates the first input voltage and the first input current. The secondary of the second transformer T2 generates the second output voltage and the second output current according to the first input voltage and the first input current. Correspondingly, the seventh switching unit SW7 is turned off, the eighth switching unit SW8 is turned on, the ninth switching unit SW9 is turned on, the tenth switching unit SW10 is turned off, the eleventh switching unit SW11 is turned on, and the twelfth switching unit SW12 is turned off. The ninth switching unit SW9 generates an output current according to the second output voltage of the secondary of the second transformer T2, and the output current is input to the output capacitor Co and the output resistor Ro to generate the output voltage.

At time t11 to t12, the first switching unit SW1 is turned off, the second switching unit SW2 is turned on, the third switching unit SW3 is turned on, the fourth switching unit SW4 is turned off, the fifth switching unit SW5 is turned off, and the sixth switching unit SW6 is turned on. Correspondingly, the seventh switching unit SW7 is turned off, the eighth switching unit SW8 is turned on, the ninth switching unit SW9 is turned on, the tenth switching unit SW10 is turned off, the eleventh switching unit SW11 is turned off, and the twelfth switching unit SW12 is turned off. The ninth switching unit SW9 generates an output current according to the second output voltage of the secondary of the second transformer T2. The output current is input to the output capacitor Co and the output resistor Ro to generate the output voltage.

In one embodiment, under the same current condition for zero-voltage switching (ZVS), the specifications of a full-bridge to full-bridge resonant converter and the specifications of a resonant converter of the present disclosure may be selected as shown in Table 1 and Table 2.

TABLE 1

| | Full-bridge to full-bridge | | Resonant converter of | |
|---|---|---|---|---|
| Specifications | resonant converter | | the present disclosure | |
| Input voltage | 400 | V | 400 | V |
| Output voltage | 49.58 | V | 49.47 | V |
| Output wattage | 10 | kW | 10 | kW |
| Switching frequency | 100 | kHz | 100 | kHz |
| Operating point | On resonant point | | On resonant point | |
| (full load) | | | | |
| Capacitor of the | 105 | pF | 105 | pF |
| primary switch | | | | |
| Dead time | 50 | ns | 50 | ns |
| Turns ratio | 16:2 | | 14:1 | |
| Magnetizing | 157.34 | μH | 245.09 | μH |
| inductance | | | | |
| Resonant capacitor | 0.38 | μF | 129.3 | nF |
| Resonant inductor | 6 | μH | 6 | μH |
| Leakage inductance | 0.65 | μH | 0.41 | μH |

It is to be noted that the turns ratios of the first transformer T1, the second transformer T2, and the third transformer T3 may be set to the values shown in Table 1. The first dead time td1 may be set to the dead time value shown in Table 1. The magnetizing inductors Lm1, Lm2, and Lm3 may be set to the magnetizing inductance values shown in Table 1. The first resonant capacitor Cr1, the second resonant capacitor Cr2, and the third resonant capacitor Cr3 may be set to the resonant capacitor values shown in Table 1. The first resonant inductor Lr1, the second resonant inductor Lr2, and the third resonant inductor Lr3 may be set to the resonant inductor values shown in Table 1. Therefore, compared with the full-bridge to full-bridge resonant converter, the embodiment of the present disclosure may reduce the number of primary winding turns.

TABLE 2

| | Full-bridge to full- | | | |
|---|---|---|---|---|
| | bridge resonant | | Resonant converter of | |
| Specifications of core | converter | | the present disclosure | |
| Cross-sectional area of | 174.04 | mm² | 174.04 | mm² |
| core center column (Ae) | | | | |
| Material | KF9 | | KF9 | |
| Maximum magnetic | 0.25 | T | 0.25 | T |
| flux density | | | | |
| (Assumption) | | | | |
| Primary coil | 0.1*500 | strands | 0.1*500 | strands |
| Secondary coil | Copper Sheet 0.6 mm | | Copper Sheet 0.6 mm | |
| Turns ratio | 16:2 | | 14:1 | |
| Air gap | 0.38 | mm | 0.12 | mm |

It is to be noted that the primary winding Np1 of the first transformer T1, the primary winding Np2 of the second transformer T2, and the primary winding Np3 of the third transformer T3 may be set to the primary coil values shown in Table 2. The secondary winding Ns1 of the first transformer T1, the secondary winding Ns2 of the second transformer T2, and the secondary winding Ns3 of the third transformer T3 may be set to the secondary coil values shown in Table 2.

The performance of the full-bridge to full-bridge resonant converter and the performance of a resonant converter of the present disclosure are shown in Table 3.

TABLE 3

| | Full-bridge to full- | |
|---|---|---|
| | bridge resonant | Resonant converter of |
| Performance parameters | converter | the present disclosure |
| Primary switch current | 14.13 | 16.6 |
| peak value (A) | | |
| Primary switch current | 7.13 | 7.36 |
| effective value (A) | | |
| Primary transformer | 10.09 | 12.02 |
| current effective value (A) | | |
| Primary switch number | 12 | 12 |
| Secondary switch current | 105.71 | 107.41 |
| peak value (A) | | |
| Secondary switch current | 52.54 | 56.15 |
| effective value (A) | | |
| Secondary transformer | 74.2 | 79.43 (Parallel |
| current effective value (A) | | connection) |
| Secondary switch number | 12 | 12 |

In the embodiment of Table 3, each of the first switching unit SW1 to the sixth switching unit S6 of the resonant converter according to the present disclosure is connected in parallel with a respective switching unit, and each of the seventh switching unit SW7 to the twelfth switching unit S12 of the resonant converter according to the present disclosure is connected in parallel with a respective switching unit. Therefore, the number of primary switches in the resonant converter of the present disclosure is the same as that in the full-bridge to full-bridge resonant converter, namely, twelve switches, and the number of secondary switches in the resonant converter of the present disclosure is the same as that in the full-bridge to full-bridge resonant converter, namely, twelve switches. As shown in Table 3, under the same number of primary and secondary switches, the current stress of the resonant converter according to the present disclosure is comparable to that of the full-bridge to full-bridge resonant converter, and thus the copper loss is also comparable. That is, the resonant converter of the present disclosure exhibits lower core loss.

The performance of the full-bridge to full-bridge resonant converter and the performance of the resonant converter according to the present disclosure are shown in Table 4.

TABLE 4

| | Full-bridge to full- | |
|---|---|---|
| | bridge resonant | Resonant converter of |
| Performance parameters | converter | the present disclosure |
| Primary connection | Full-bridge | According to the |
| | | present disclosure |
| Secondary connection | Full-bridge | wye connection |
| Output voltage | Vo | Vo |
| Turns ratio | Np | Np*1.75 |
| Operating frequency | On resonant point | On resonant point |
| Maximum magnetic flux density | $\frac{1}{4} \cdot \frac{Nps \cdot {V}_{o} \cdot {T}_{s}}{NP \cdot A}$ | $\approx \frac{1}{9} \cdot \frac{Nps \cdot {V}_{o} \cdot {T}_{s}}{NP \cdot A}$ |
| Current Peak Value (calculating ZVS | $\frac{1}{4} \cdot \frac{Nps \cdot {V}_{o} \cdot {T}_{s}}{{L}_{m \_ F}}$ | $\frac{1.75}{9} \cdot \frac{Nps \cdot {V}_{o} \cdot {T}_{s}}{{L}_{m \_ Y}}$ |
| condition) | | |
| Magnetizing inductance | ${L}_{m \_ F} = \frac{9}{8} \cdot {L}_{m}$ | Lₘ_Y ≈ 1.55 · Lₘ_H |

As shown in Table 4, the resonant converter according to the embodiment of the present disclosure has a lower magnetic flux density compared to the full-bridge to full-bridge resonant converter. Accordingly, under the same magnetic core, a core loss of the resonant converter of the present disclosure is smaller.

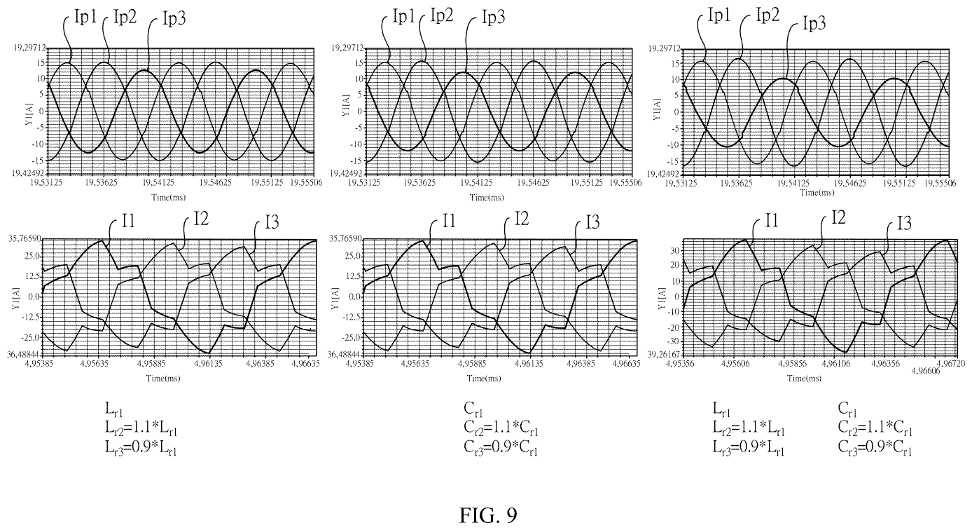

Please refer to FIG. 2 and FIG. 9. FIG. 9 is a comparative diagram showing three-phase current errors among a resonant converter according to an embodiment of the present disclosure and a full-bridge to full-bridge resonant converter. The first current I1, the second current I2, and the third current I3 are three-phase currents flowing into the resonant circuit (e.g., the resonant circuit 300 of the present disclosure).

The upper part of FIG. 9 shows current variation values of a first current Ip1, a second current Ip2, and a third current Ip3 of the full-bridge to full-bridge resonant converter. The lower half of FIG. 9 shows current variation values of the input current I1, the input current I2, and the input current I3 of the resonant converter according to the embodiment of the present disclosure. The first current Ip1 is in phase with the input current I1, the second current Ip2 is in phase with the input current I2, and the third current Ip3 is in phase with the input current I3. The left part of FIG. 9 shows current variations of the full-bridge to full-bridge resonant converter and the present disclosure when an inductance value of the second resonant inductor Lr2 is 1.1 times an inductance value of the first resonant inductor Lr1 and an inductance value of the third resonant inductor Lr3 is 0.9 times an inductance value of the first resonant inductor Lr1. The middle part of FIG. 9 shows current variations when a capacitance value of the second resonant capacitor Cr2 is 1.1 times a capacitance value of the first resonant capacitor Cr1 and a capacitance value of the third resonant capacitor Cr3 is 0.9 times a capacitance value of the first resonant capacitor Cr1. The right part of FIG. 9 shows current variations when an inductance value of the second resonant inductor Lr2 is 1.1 times an inductance value of the first resonant inductor Lr1, an inductance value of the third resonant inductor Lr3 is 0.9 times an inductance value of the first resonant inductor Lr1, a capacitance value of the second resonant capacitor Cr2 is 1.1 times a capacitance value of the first resonant capacitor Cr1, and a capacitance value of the third resonant capacitor Cr3 is 0.9 times a capacitance value of the first resonant capacitor Cr1. In FIG. 9, a peak value difference of the input current I1, the input current I2 and the input current I3 of the embodiment of the present disclosure under different component errors is smaller than a peak value difference of the first current Ip1, the second current Ip2 and the third current Ip3 of the full-bridge to full-bridge resonant converter under different component errors. That is, a current difference caused by the component errors of the resonant converter of the embodiment of the present disclosure is smaller than a current difference caused by the component error of the full-bridge to full-bridge resonant converter. Therefore, the resonant converter of the present disclosure has a higher tolerance to the current error caused by the component errors.

The performance of the full-bridge to full-bridge resonant converter and the performance of the resonant converter of the present disclosure are shown in Table 5.

TABLE 5

| | | Full-bridge to full- | | Resonant | |
|---|---|---|---|---|---|
| | | bridge resonant | | converter of the | |
| Resonant inductor current | | converter | | present disclosure | |
| Component | I_{Lr1} | 14.12 | A | 20.81 | A |
| error-free | I_{Lr2} | 14.12 | A | 20.81 | A |
| | I_{Lr3} | 14.12 | A | 20.81 | A |
| Resonant | I_{Lr1} | 14.74 | A (+4.39%) | 20.90 | A (+0.43%) |
| inductor error | I_{Lr2} | 12.61 | A (−10.69%) | 21.58 | A (+3.7%) |
| | I_{Lr3} | 15.03 | A (+6.45%) | 20.02 | A (−3.79%) |
| Resonant | I_{Lr1} | 15.01 | A (+6.3%) | 20.86 | A (+0.24%) |
| capacitor error | I_{Lr2} | 11.98 | A (−15.15%) | 21.53 | A (+3.46%) |
| | I_{Lr3} | 15.45 | A (+9.41%) | 20.19 | A (−2.97%) |
| Resonant | I_{Lr1} | 15.72 | A (+11.33%) | 20.91 | A (+0.48%) |
| inductor and | I_{Lr2} | 10.54 | A (−25.35%) | 22.35 | A (+7.4%) |
| resonant | I_{Lr3} | 16.46 | A (+16.57%) | 19.42 | A (−6.67%) |
| capacitor error | | | | | |

In Table 5, I_{Lr1}, I_{Lr2} and I_{Lr3} represent currents of the first resonant inductor Lr1, the second resonant inductor Lr2 and the third resonant inductor Lr3, respectively. Accordingly, when an error in the components of the resonant converter of the embodiment of the present disclosure exists, change values of the currents of the resonant inductors are significantly smaller than change values of the currents of the resonant inductors of the full-bridge to full-bridge resonant converter. The current difference caused by component errors in the resonant converter of the embodiment of the present disclosure is smaller than the current difference caused by component errors in the full-bridge to full-bridge resonant converter.

In the embodiment of the present disclosure, the plurality of resonant inductors and the plurality of transformers of the resonant converter may be implemented by separate magnetic cores or by a single integrated magnetic core module.

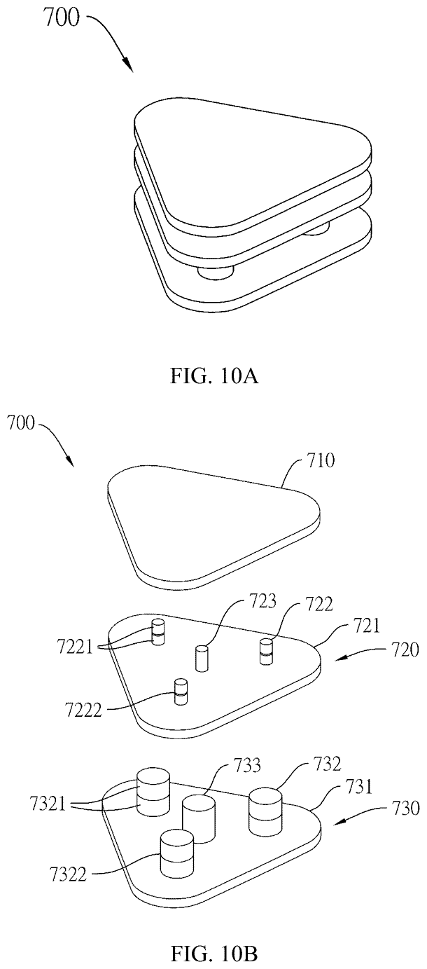

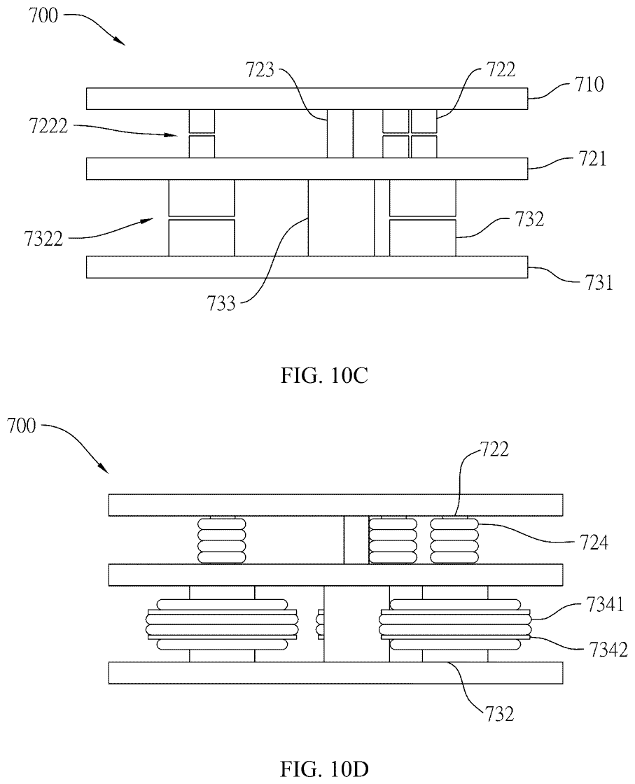

Please refer to FIG. 10A to FIG. 10C. FIG. 10A is a perspective schematic diagram of an integrated magnetic core module according to an embodiment of the present disclosure. FIG. 10B is another perspective schematic diagram of an integrated magnetic core module according to an embodiment of the present disclosure. FIG. 10C is a cross-sectional schematic diagram of an integrated magnetic core module according to an embodiment of the present disclosure.

The integrated magnetic core module 700 includes an upper cover 710, an integrated transformer 730, and an integrated resonant inductor unit 720. The integrated resonant inductor unit 720 is disposed between the upper cover 710 and the integrated transformer 730.

The integrated transformer 730 includes a lower cover 731, a plurality of transformer core columns 732, and a transformer common column 733. The plurality of transformer core columns 732 and the transformer common column 733 are disposed on the lower cover 731. The plurality of transformer core columns 732 are arranged around the transformer common column 733. Distances between the plurality of transformer core columns 732 and the transformer common column 733 are the same. By setting the distances between the plurality of transformer core columns 732 and the transformer common column 733 to be equal, the magnetic flux balance among the phases may be effectively maintained. In one embodiment, the transformer common column 733 is disposed at the center of the lower cover 731.

Each transformer core column 732 includes two core column units 7321. The two core column units 7321 are stacked on top of each other. An air gap 7322 is formed between the two core column units 7321. The size of the air gap 7322 of each transformer core column 732 is the same.

A cross-sectional area of each of the plurality of transformer core columns 732 is the same as a cross-sectional area of the transformer common column 733. Since the magnetic flux flowing through the plurality of transformer core columns 732 is the same as the magnetic flux flowing through the transformer common column 733, the cross-sectional area of the transformer common column 733 must be at least the same as the cross-sectional area of the plurality of transformer core columns 732 to avoid a magnetic flux saturation of the plurality of transformer core columns 732.

Please refer to FIG. 10D. Each transformer core column 732 of the integrated magnetic core module 700 is provided with a primary coil 7341 and a secondary coil 7342. The primary coil 7341 is, for example, the aforementioned primary winding Np1, primary winding Np2 or primary winding Np3. The secondary coil 7342 is, for example, the aforementioned secondary winding Ns1, the secondary winding Ns2 or the secondary winding Ns3. A winding direction of the primary coil 7341 and the secondary coil 7342 is clockwise or counterclockwise. Therefore, the above-mentioned plurality of transformers (the first transformer T1, the second transformer T2 and the third transformer T3) may be individually implemented by a set of the transformer core column 732, the primary coil 7341 and the secondary coil 7342. A location of the plurality of transformers in the integrated transformer 730 is variable. Taking FIG. 10A as an example, with the transformer core column 732 as a reference, the first transformer T1, the second transformer T2, and the third transformer T3 may be arranged sequentially in the clockwise direction, or, alternatively, may be arranged sequentially in the counterclockwise direction as the first transformer T1, the second transformer T2, and the third transformer T3.

In one embodiment, the primary coil 7341 is wound from, for example, a Litz wire. Since the air gap 7322 is located at the center of the transformer core column 732, an AC loss caused by the air gap 7322 may be effectively reduced by the Litz wire. In one embodiment, the secondary coil 7342 is wound from, for example, a copper sheet. Since the current of the secondary coil 7342 is relatively large, a copper sheet that may carry a relatively large current is selected.

The integrated resonant inductor unit 720 includes a middle cover 721, a plurality of inductor core columns 722, and an inductor common column 723. The middle cover 721 is located on the plurality of transformer core columns 732 and the transformer common column 733 and is away from the lower cover 731. The plurality of inductor core columns 722 and the inductor common columns 723 are disposed on the middle cover 721. The plurality of inductor core columns 722 are disposed around the inductor common column 723. The distances between the plurality of inductor core columns 722 and the inductor common column 723 are the same. Because the distances between the plurality of inductor core columns 722 and the inductor common column 723 are the same, the magnetic flux balance between the phases may be effectively maintained. In one embodiment, the inductor common column 723 may be disposed at the center of the middle cover 721. In one embodiment, a vertical projection of the inductor common column 723 on the middle cover 721 and a vertical projection of the transformer common column 733 on the middle cover 721 may at least partially overlap or may not overlap.

Each inductor core column 722 includes two core column units 7221. The two core column units 7221 are stacked on top of each other. An air gap 7222 is formed between the two core column units 7221. The size of the air gap 7222 of each inductor core column 722 is the same. In one embodiment, the air gap 7222 of the inductor core column 722 is larger than the air gap 7322 of the transformer core column 732. The size of the air gap 7222 is, for example, at least three times the size of the air gap 7322.

A cross-sectional area of the plurality of inductor core columns 722 is the same as a cross-sectional area of the inductor common column 723. Since the magnetic flux flowing through the multiple inductor core columns 722 is the same as the magnetic flux flowing through the inductor common column 723, the cross-sectional area of the inductor common column 723 must be at least the same as the cross-sectional area of the multiple inductor core columns 722 to avoid the magnetic flux saturation of the multiple inductor core columns 722. In one embodiment, the cross-sectional area of the transformer core column 732 is greater than the cross-sectional area of the inductor core column 722. The cross-sectional area of the transformer core column 732 is, for example, at least twice the cross-sectional area of the inductor core column 722.

As shown in FIG. 10D, each of the inductor core columns 722 is provided with an inductor coil 724. The winding direction of the inductor 724 is clockwise or counterclockwise. The plurality of resonant inductors (the first resonant inductor Lr1, the second resonant inductor Lr2, and the third resonant inductor Lr3) may be individually implemented by a set of inductor core columns 722 and an inductor coil 724. The positions of the plurality of resonant inductors in the integrated resonant inductor unit 720 are variable. For example, as shown in FIG. 10A, with the plurality of inductor core columns 722 as a reference, in a clockwise direction, they may be the first resonant inductor Lr1, the second resonant inductor Lr2 and the third resonant inductor Lr3, or in a counter-clockwise direction, they may be the first resonant inductor Lr1, the second resonant inductor Lr2 and the third resonant inductor Lr3. The positions of the plurality of resonant inductors in the integrated resonant inductor unit 720 are not limited by the positions of the plurality of transformers in the integrated transformer 730. For example, the first resonant inductor Lr1 may be disposed above the second transformer T2 instead of being disposed above the first transformer T1.

In one embodiment, the inductor 724 is wound from, for example, a Litz wire. Since the air gap 7222 is located at the center of the inductor core column 722, the AC loss caused by the air gap 7222 may be effectively reduced by using the Litz wire.

In one embodiment, shapes of the upper cover 710, the middle cover 721, and the lower cover 731 may be corresponded to each other. The shapes of the upper cover 710, the middle cover 721, and the lower cover 731 may be circular, square, or triangular, and the present disclosure is not limited thereto.

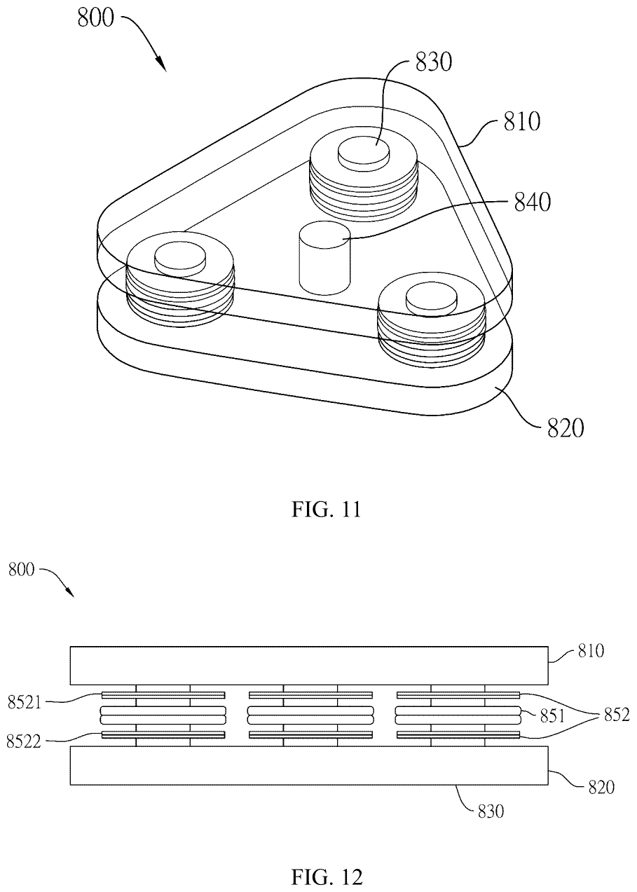

Please refer to FIG. 11 and FIG. 12. FIG. 11 is a further perspective schematic diagram of an integrated magnetic core module according to an embodiment of the present disclosure. FIG. 12 is another cross-sectional schematic diagram of an integrated magnetic core module according to an embodiment of the present disclosure. The integrated magnetic core module 800 includes an upper cover 810, a lower cover 820, a plurality of core columns 830 and a common column 840. The core columns 830 and the common column 840 are disposed between the upper cover 810 and the lower cover 820. Please refer to FIG. 10B. The plurality of core columns 830 may be implemented by the plurality of transformer core columns 732 and the common column 840 may be implemented by the transformer common column 733 and thus will not be described in detail herein.

Each of the core columns 830 is provided with a primary coil 851 and a secondary coil 852. The winding direction of the primary coil 851 and the secondary coil 852 is clockwise or counterclockwise. There is a distance between the primary coil 851 and the secondary coil 852. The plurality of transformers (the first transformer T1, the second transformer T2, and the third transformer T3) mentioned above may be implemented by a core column 830, a primary coil 851, and a secondary coil 852, respectively. In this embodiment, the plurality of resonant inductors are implemented by leakage inductances of the plurality of transformers. The magnitude of the leakage inductance is proportional to the distance between the primary coil 851 and the secondary coil 852. For example, the first resonant inductor Lr1 is implemented by the leakage inductance of the first transformer T1. In this embodiment, the volume of the resonant converter may be greatly reduced by implementing the resonant inductor using the leakage inductance of the transformer. In this embodiment, the primary coil 851 must be centrally wound. That is, the primary coil 851 is not implemented by a plurality of separate coils.

In this embodiment, the secondary coil 852 may be implemented as a single coil or a plurality of separate coils. In one embodiment, the secondary coil 852 includes a first secondary coil unit 8521 and a second secondary coil unit 8522. The primary coil 851 is located between the first secondary coil unit 8521 and the second secondary coil unit 8522. The primary coil 851 has a distance from the first secondary coil unit 8521 and the second secondary coil unit 8522.

In one embodiment, the primary coil 851 is wound from, for example, a Litz wire. In one embodiment, the secondary coil 852 is wound from, for example, a copper sheet.

According to the above, since the resonant converter of the present disclosure may reduce the magnetic flux density through the configuration of the plurality of resonant tanks, the core loss may be reduced accordingly, and a better current balancing effect is achieved when there are characteristic errors in the components. Therefore, the effect of balancing the currents of each phase without increasing the product volume and production cost of the power supply circuit is achieved.

It is to be understood that the term “comprises”, “comprising”, or any other variants thereof, is intended to encompass a non-exclusive inclusion, such that a process, method, article, or device of a series of elements not only includes those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiments, the embodiments are not intended to limit the present invention. It will be apparent to those skilled in the art having regard to this present invention that other modifications of the exemplary embodiments beyond those embodiments specifically described herein may be made without departing from the spirit of the invention. Accordingly, such modifications are considered within the scope of the invention as limited solely by the appended claims.

What is claimed is:

1. A resonant converter, comprising:
an input circuit, configured to provide an input voltage;
a primary switching circuit, coupled to the input circuit, comprising a first output node, a second output node and a third output node;
a resonant circuit, comprising a plurality of resonant tanks, wherein each of the plurality of resonant tanks comprises a resonant capacitor and a resonant inductor connected in series, and the plurality of resonant tanks are coupled to the first output node, the second output node and the third output node in a Wye connection;
a transformer circuit, comprising a plurality of transformers, wherein each of the plurality of transformers comprises a primary winding and a second winding, and the primary windings are coupled to the plurality of resonant tanks in a delta connection;
a secondary switching circuit, coupled to the transformer circuit, comprising a first input node, a second input node and a third input node, wherein the first input node, the second input node and the third input node are coupled to the second windings of the transformer circuit in the Wye connection; and
an output circuit, coupled to the secondary switching circuit, configured to generate an output voltage.

2. The resonant converter as claimed in claim 1, the primary switching circuit comprising:
a first bridge arm, comprising a first switching unit and a second switching unit connected in series, wherein the first output node is located between the first switching unit and the second switching unit;
a second bridge arm, comprising a third switching unit and a fourth switching unit connected in series, wherein the second output node is located between the third switching unit and the fourth switching unit; and
a third bridge arm, comprising a fifth switching unit and a sixth switching unit connected in series, wherein the third output node is located between the fifth switching unit and the sixth switching unit.

3. The resonant converter as claimed in claim 2, wherein a control signal of the first switching unit and a control signal of the second switching unit are complementary to each other, a control signal of the third switching unit and a control signal of the fourth switching unit are complementary to each other, and a control signal of the fifth switching unit and a control signal of the sixth switching unit are complementary to each other.

4. The resonant converter as claimed in claim 3, wherein a dead time is between the control signal of the first switching unit and the control signal of the second switching unit, the control signal of the third switching unit and the control signal of the fourth switching unit, and the control signal of the fifth switching unit and the control signal of the sixth switching unit.

5. The resonant converter as claimed in claim 2, wherein a phase difference between the control signal of the first switching unit and the control signal of the third switching unit is 120 degrees, and a phase difference between the control signal of the third switching unit and the control signal of the fifth switching unit is 120 degrees.

6. The resonant converter as claimed in claim 1, the transformer circuit comprising:
a first transformer, wherein the primary winding of the first transformer is coupled to the resonant circuit, and the second winding of the first transformer is coupled to the first input node of the secondary switching circuit;
a second transformer, wherein the primary winding of the second transformer is coupled to the resonant circuit, and the second winding of the second transformer is coupled to the second input node of the secondary switching circuit; and
a third transformer, wherein the primary winding of the third transformer is coupled to the resonant circuit, and the second winding of the third transformer is coupled to the third input node of the secondary switching circuit.

7. The resonant converter as claimed in claim 6, the resonant circuit comprising:
a first resonant tank, comprising a first resonant inductor and a first resonant capacitor, wherein the first resonant inductor is coupled to the first output node and the first resonant capacitor, and the first resonant capacitor is coupled to the primary winding of the transformer circuit;
a second resonant tank, comprising a second resonant inductor and a second resonant capacitor, wherein the second resonant inductor is coupled to the second output node and the second resonant capacitor, and the second resonant capacitor is coupled to the primary winding of the transformer circuit; and
a third resonant tank, comprising a third resonant inductor and a third resonant capacitor, wherein the third resonant inductor is coupled to the third output node and the third resonant capacitor, and the third resonant capacitor is coupled to the primary winding of the transformer circuit.

8. The resonant converter as claimed in claim 7, wherein the first resonant capacitor is coupled between the first resonant inductor and an output terminal of the primary winding of the third transformer.

9. The resonant converter as claimed in claim 7, wherein the first resonant inductor is coupled between the first output node and an output terminal of the primary winding of the third transformer.

10. The resonant converter as claimed in claim 7, wherein the first resonant inductor is coupled between the first output node, an output terminal of the primary winding of the third transformer, and the first resonant capacitor.

11. The resonant converter as claimed in claim 6, the resonant circuit comprising:
a first resonant tank, comprising a first resonant inductor and a first resonant capacitor, wherein the first resonant capacitor is coupled to the first output node and the first resonant inductor, and the first resonant inductor is coupled to the primary winding of the transformer circuit;
a second resonant tank, comprising a second resonant inductor and a second resonant capacitor, the second resonant capacitor is coupled to the second output node and the second resonant inductor, and the second resonant inductor is coupled to the primary winding of the transformer circuit; and
a third resonant tank, comprising a third resonant inductor and a third resonant capacitor, wherein the third resonant capacitor is coupled to the third output node and the third resonant inductor, and the third resonant inductor is coupled to the primary winding of the transformer circuit.

12. The resonant converter as claimed in claim 11, wherein the first resonant capacitor is coupled between the first output node and an output terminal of the primary winding of the third transformer.

13. The resonant converter as claimed in claim 1, the secondary switching circuit comprising:
a first rectification unit, comprising a seventh switching unit and an eighth switching unit connected in series, wherein the first input node is located between the seventh switching unit and the eighth switching unit;
a second rectification unit, comprising a ninth switching unit and a tenth switching unit connected in series, wherein the second input node is located between the ninth switching unit and the tenth switching unit; and
a third rectification unit, comprising an eleventh switching unit and a twelfth switching unit connected in series, wherein the third input node is located between the eleventh switching unit and the twelfth switching unit.

14. The resonant converter as claimed in claim 1, wherein the resonant inductors and the transformers are integrated in an integrated magnetic core module.

15. The resonant converter as claimed in claim 14, wherein the integrated magnetic core module comprises an upper cover, an integrated transformer and an integrated resonant inductor unit, and the integrated resonant inductor unit is disposed between the upper cover and the integrated transformer.

16. The resonant converter as claimed in claim 15, wherein the integrated transformer comprises a lower cover, a plurality of transformer core columns and a transformer common column, the plurality of transformer core columns and the transformer common column are disposed on the lower cover, the plurality of transformer core columns are arranged around the transformer common column, cross-sectional areas of the plurality of transformer core columns are same as a cross-sectional area of the transformer common column, and distances between the plurality of transformer core columns and the transformer common column are the same.

17. The resonant converter as claimed in claim 16, wherein the integrated resonant inductor unit comprises a middle cover, a plurality of inductor core columns and an inductor common column, the plurality of inductor core columns and the inductor common column are disposed on the middle cover, the plurality of inductor core columns are arranged around the inductor common column, cross-sectional areas of the plurality of inductor core columns are the same as a cross-sectional area of the inductor common column, and distances between the plurality of inductor core columns and the inductor common column are the same.

18. The resonant converter as claimed in claim 17, wherein the cross-sectional areas of the plurality of transformer core columns are greater than the cross-sectional area of the plurality of inductor core columns.

19. The resonant converter as claimed in claim 17, wherein air gaps of the plurality of transformer core columns are greater than air gaps of the plurality of inductor core columns.

20. The resonant converter as claimed in claim 19, wherein the resonant inductor adjacent to the air gap of the inductor core column is formed by winding a Litz wire, and the transformer adjacent to the air gap of the transformer core column is formed by winding a Litz wire.

21. The resonant converter as claimed in claim 14, wherein the integrated magnetic core module comprises an upper cover, a lower cover, a plurality of core columns and a common column, the plurality of core columns and the common column are disposed between the upper cover and the lower cover, the plurality of core columns are arranged around the common column, cross-sectional areas of the plurality of core columns are the same as a cross-sectional area of the common column, and distances between the plurality of core columns and the common column are the same.

22. The resonant converter as claimed in claim 21, wherein the plurality of resonant inductors are formed by leakage inductances of the plurality of transformers.

23. The resonant converter as claimed in claim 21, wherein each of the plurality of core columns comprises the primary winding and the secondary winding of one transformer, and a distance is between the primary winding and the secondary winding.

24. The resonant converter as claimed in claim 23, wherein the secondary winding comprises a first secondary coil unit and a second secondary coil unit, and the primary winding is disposed between the first secondary coil unit and the second secondary coil unit.

25. The resonant converter as claimed in claim 14, wherein the primary winding is formed by winding a Litz wire, and the secondary winding is formed by winding a copper sheet.
